(19) United States
(12) Patent Application Publication
(10) Pub. No.: US 2016/0148593 A1
(43) Pub. Date: May 26, 2016

(54) ENTERTAINMENT UNITS, ENTERTAINMENT SYSTEMS, AND METHODS FOR USING SAME

(71) Applicant: Votsh, Campbell, CA (US)

(72) Inventor: Frank Cohen, Campbell, CA (US)

(21) Appl. No.: 14/868,368

(22) Filed: Sep. 28, 2015

Related U.S. Application Data
(60) Provisional application No. 62/056,384, filed on Sep. 26, 2014.

(51) Int. Cl. G09G 5/00; G06T 13/00; G02B 5/02; G09G 5/12; G09G 5/391; G06T 15/50; G06F 3/14

(52) U.S. Cl. CPC G09G 5/005; G06T 15/506; G06T 13/00; G06F 3/1446; G09G 5/12; G09G 5/391; G02B 5/0294; G09G 2370/16; G09G 2300/026; G09G 2360/04

(57) ABSTRACT

Multiple entertainment units may be set up in an array and may communicate with one another over wireless networks to organize and present detailed multi-location shows including light, sound, and/or animation. In some instances, entertainment units as well as the systems and methods described herein may be utilized by users to visualize music streams, make light and sound shows based on the occurrence of events in, for example, a calendar or social media and provide opportunities to purchase and/or share created shows with other users.

### RELATED APPLICATION

This application is a NON-PROVISIONAL of U.S. Provisional Patent Application Ser. No. 62/056,384, filed Sep. 26, 2014 entitled “ENTERTAINMENT UNITS, ENTERTAINMENT SYSTEMS, AND METHODS FOR USING SAME,” which is incorporated herein by reference, in its entirety.

### FIELD OF THE INVENTION

The present invention relates to entertainment units, entertainment systems, and methods for using same to provide a show to one or more observers/users.

### BACKGROUND

Traditionally, audio/visual display devices are limited to a single screen such as a television or computer monitor and communication between one television screen and another is not enabled. Thus, coordination of a presentation between the screens is not possible.

### BRIEF DESCRIPTION OF THE DRAWINGS

The present invention is illustrated by way of example, and not limitation, in the figures of the accompanying drawings, in which:

FIG. 1 is a block diagram of an exemplary system in accordance with some embodiments of the present invention;

FIGS. 2A-D are diagrams depicting an exemplary entertainment unit in accordance with some embodiments of the present invention;

FIGS. 3 and 4 are exemplary entertainment units in accordance with some embodiments of the present invention;

FIG. 5 is diagram of an exemplary interface in accordance with some embodiments of the present invention;

FIGS. 6 and 7 are diagrams of exemplary arrays of entertainment units in accordance with some embodiments of the present invention;

FIG. 8 is a block diagram of an exemplary system in accordance with some embodiments of the present invention;

FIGS. 9 and 10 are flowcharts depicting exemplary processes in accordance with some embodiments of the present invention;

FIG. 11 is a diagram of an exemplary grid in accordance with some embodiments of the present invention;

FIG. 12 is a diagram of an exemplary grid with entertainment units placed therein in accordance with some embodiments of the present invention;

FIG. 13 is a diagram of an exemplary grid with entertainment units placed therein and a sprite moving from one entertainment unit to another entertainment unit in the grid in accordance with some embodiments of the present invention;

FIG. 14 is a diagram depicting an array of entertainment units being observed in accordance with some embodiments of the present invention; and

FIG. 15 is a diagram depicting an exemplary peer-to-peer environment in accordance with some embodiments of the present invention.

### DETAILED DESCRIPTION

Described herein is a wirelessly enabled computing platform and device (hereinafter called an “entertainment unit”) that uses color, light, sound, and animation to entertain people via a show. A show is a defined set of data corresponding to, for example, a light, sound, and/or animation display to be played or presented by one or more entertainment units 200 over a period of time.

In accordance with the present invention, multiple entertainment units may be set up in an array and may communicate with one another over wireless networks to organize and present detailed multi-location shows including light, sound, and/or animation. In some instances, entertainment units as well as the systems and methods described herein may be utilized by users to visualize music streams, make light and sound shows based on the occurrence of events in, for example, a calendar or social media (e.g., FACEBOOK™, TWITTER™, etc.), and provide opportunities to purchase and/or share created shows with other users. Entertainment units may also be implemented to entertain large groups of people, for example, forming a large interactive light and sound display at concerts and events, and bring calmness to a user's life and experiences with, for example, guided meditation or hypnosis using light and/or sound. Individual entertainment units may be of any size and configuration may be, for example, sized and configured for positioning on a table surface, ceiling, and/or wall and may be scaled to meet any dimensional criteria.

In many embodiments, shows are expressed in predefined data formats, which may need to be adapted or transformed for presentation on one or more entertainment units. In many instances, show data may be formatted for control identities for the scheduled and event-driven criteria used to run a show on one more entertainment units. Light data included within show data may provide a format for controlling or identifying time, color, and/or luminosity of each light effect in a show. Sound data included within show data may provide a format to control audio, musical, and spoken word communication. On some occasions, show data may include protocols to learn the current status of each entertainment unit and controller, a status of file transfers, and may also learn controls to run, pause, and stop shows running in entertainment units.

The entertainment units may be arranged in any pleasing physical layout, including, but not limited to, spread around a desk surface, hung from the walls in a home theater, and/or distributed around event space for large social events, like a wedding or convention.

Shows are collections of control data, including light and sound cues along the timeline for the provision of show data as, for example, a light, sound, and/or animation by one or more entertainment units. Shows provide data to control all of the entertainment units within a plurality as a whole using, for example, a wired or wireless network, a wired or wireless coordinated show controller, and show protocols to distribute the light and sound effect instructions to control shows that span multiple display/entertainment units.

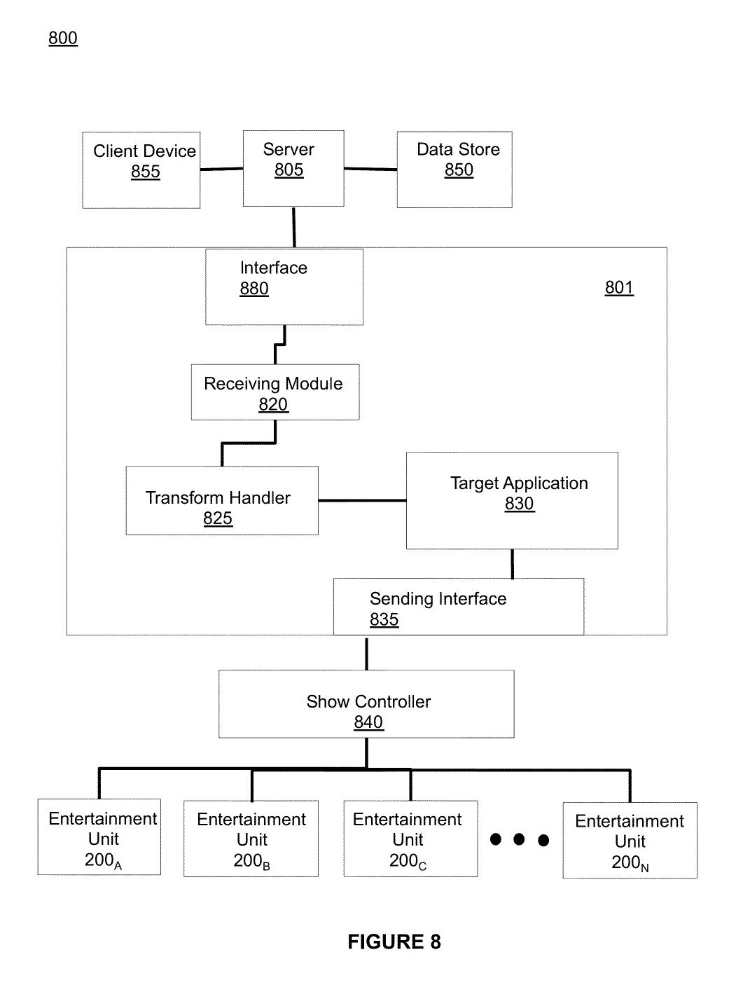

In one embodiment, a distributed entertainment-operating environment 800, as discussed below with regard to FIG. 8, may provide schedule-based automated operation of shows across multiple entertainment units. Exemplary entertainment units may include lights arranged in a matrix to shine on a set of diffusion filters while playing music and sound effects from a built-in amplified speaker.

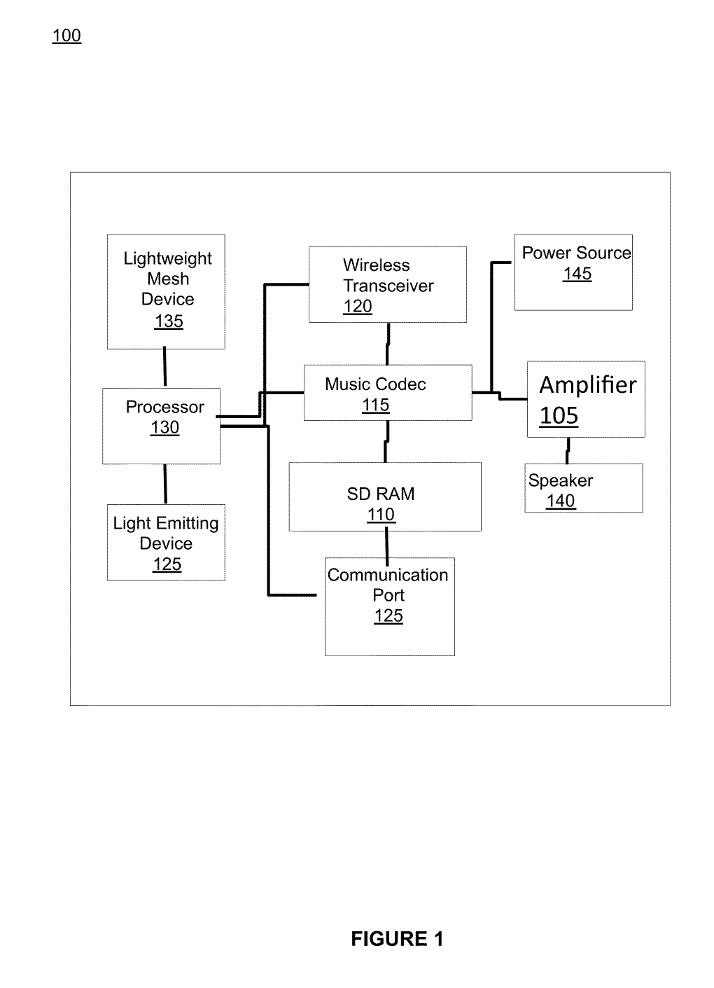

FIG. 1A depicts exemplary components of a controller 100 of an entertainment unit 200 including an amplifier 105, an SD RAM card 110, a music codec 115, a wireless transceiver 120, a power source (AC, DC, battery) 145, input keypad, a light emitting device (e.g., LEDs or light bulbs) 125, a processor 130, a lightweight mesh radio network device 135, a communication port 150, and a speaker 140. A person of skill in the art will understand that the components of controller 100 may be arranged in any fashion.

Lightweight mesh radio network device 135 and/or wireless transceiver 120 may enable an entertainment unit to communication with, for example, other entertainment units, a show controller, a logic engine, a user's computing device, and/or a server. Exemplary wireless transceivers 120 include a BLUETOOTH™ networking device, a near-field communication (NFC) device, Infrared wireless networks, a BLUETOOTH™ Low Energy (BLE) device, or some combination thereof, Processor 130 may be, for example, an Arduino Pinoccio processor, or the like.

Light emitting device 125 may be, for example, an array of various light emitting devices, like LEDs, that may change color and/or may be an array of light emitting devices that are of a single color. The light emitting devices 125 may be arranged in any format and will typically be positioned on only one surface (e.g., the top surface) of an entertainment unit. In some instances, light emitting device(s) 125 may be arranged so that their position corresponds to a position of one or more diffusion filters so as to shine directly and/or indirectly upon the diffusion filter(s).

Music codec 115 may be a device and/or computer program configured to encode or decode a digital music signal or data stream. SD RAM 110 may be store one or more sets of instructions as well as other data for enabling the operation of an entertainment unit. Power source 145 may be any appropriate device for the power to and entertainment either via battery for wall plug-in to an electric socket. Amplifier 105 may serve to amplify a sound signal prior to its communication to speaker 140 and speaker 140 may serve to broadcast or otherwise transmit audio data or sound from an entertainment unit. Processor 130 may be configured to receive control and command data from one or more components described below with regard to FIG. 8 so as to run a show.

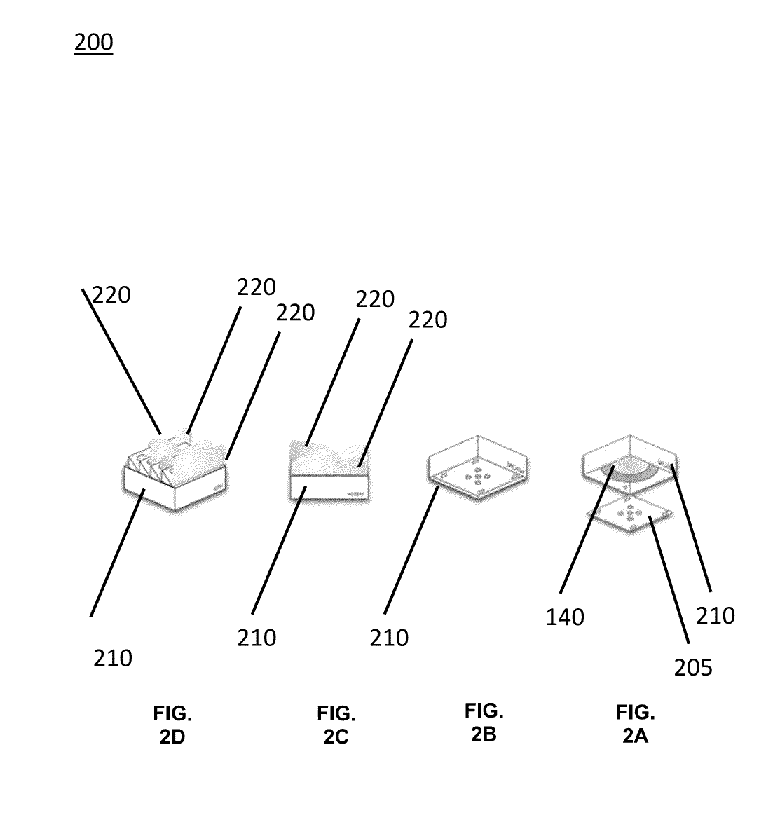

FIGS. 2A-2D depict an assembly process for an exemplary entertainment unit 200. FIG. 2A depicts a exploded view of a base 210 for an entertainment unit 200. Of course, a person of skill in the art would recognize that controller 100 may be placed anywhere in base 210. Resident inside base 210 may be speaker 140. As depicted in FIG. 2A, speaker 140 is positioned to coincide with an upper surface of base 210 but this need not be the case. For example, speaker 140 may be positioned to coincide with a side of base 210 and, in instances where base 210 includes 2 or more speakers 140, they may be placed symmetrically within unit (e.g., on opposing sides of base 210). Additionally or alternatively, speaker 140 may be placed on a top or side of base 210 so as to extend outwardly therefrom.

FIG. 2B depicts bottom perspective view of an assembled entertainment unit base 210, without diffusion filters 220. FIG. 2C depicts a front view of the entertainment unit base 210 with a plurality of diffusion filters 220 placed on top and FIG. 2D depicts a side perspective view of the entertainment unit 200 base 210 with diffusion filters 220 placed on top. Diffusion filters 220 may be configured to diffuse light projected thereon by the light source and, in some instance, may be opaque, semi-opaque, or have a frosted or otherwise textured finish. Diffusion filters 220 may be made from any appropriate material including, but not limited to, plastic, glass, and electrically sensitive materials.

Diffusion filters 220 may be user configurable. Examples of possible user configurations include selection of a size, shape, orientation, color or degree of opacity for the diffusion filter. A user may also be able to configure the shape of a diffusion filter 220 by, for example, cutting away a portion or adding a portion of diffusion filter 220. Additionally, or alternatively a user may also be able to configure the color of a diffusion filter 220 by writing and/or printing on or otherwise coloring diffusion filter 220 or a portion thereof.

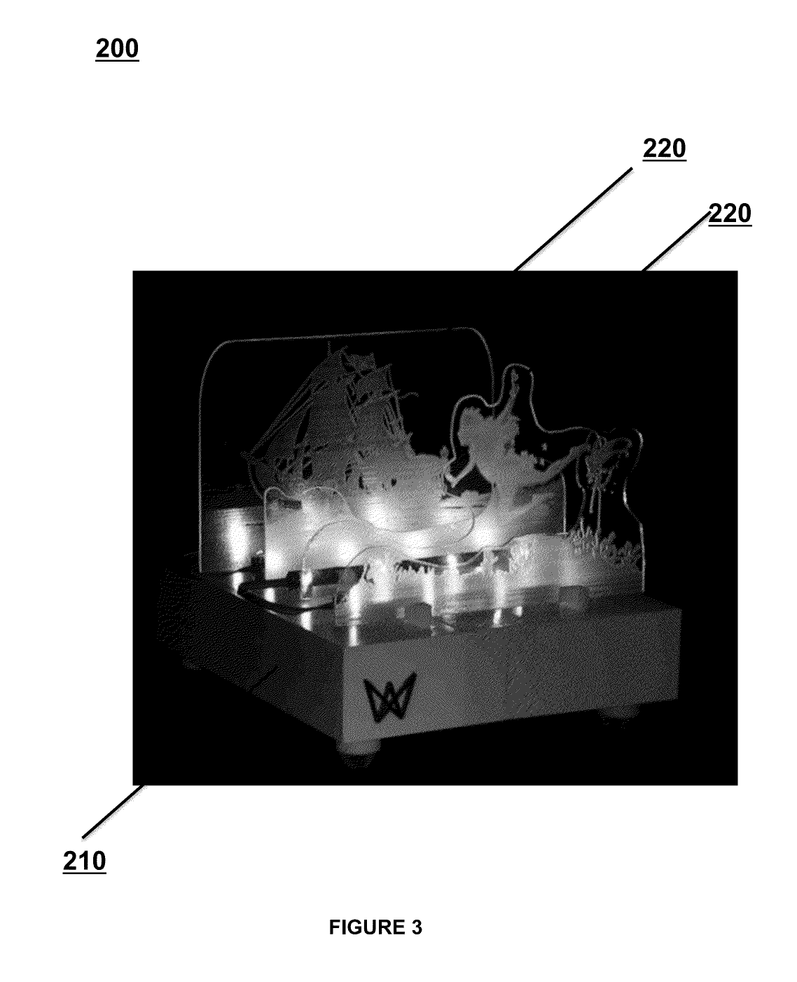

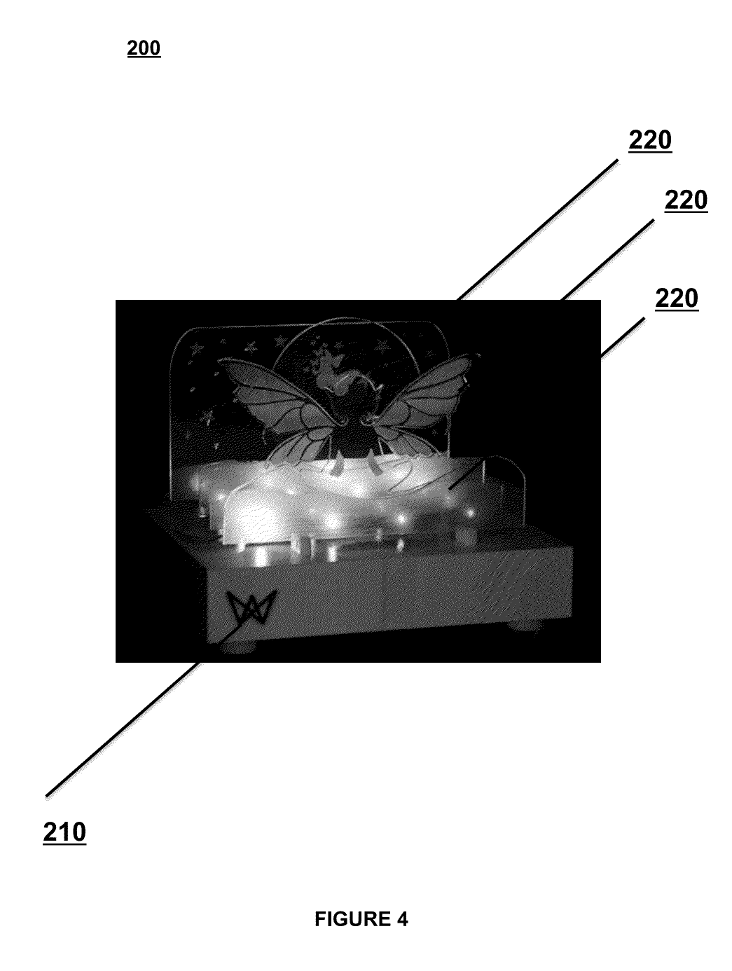

In some embodiments, the diffusion filters 220 may include pre-printed textures, images, or patterns. Examples of diffusion filters 220 with pre-printed images and patterns included thereon are provided in FIGS. 3 and 4.

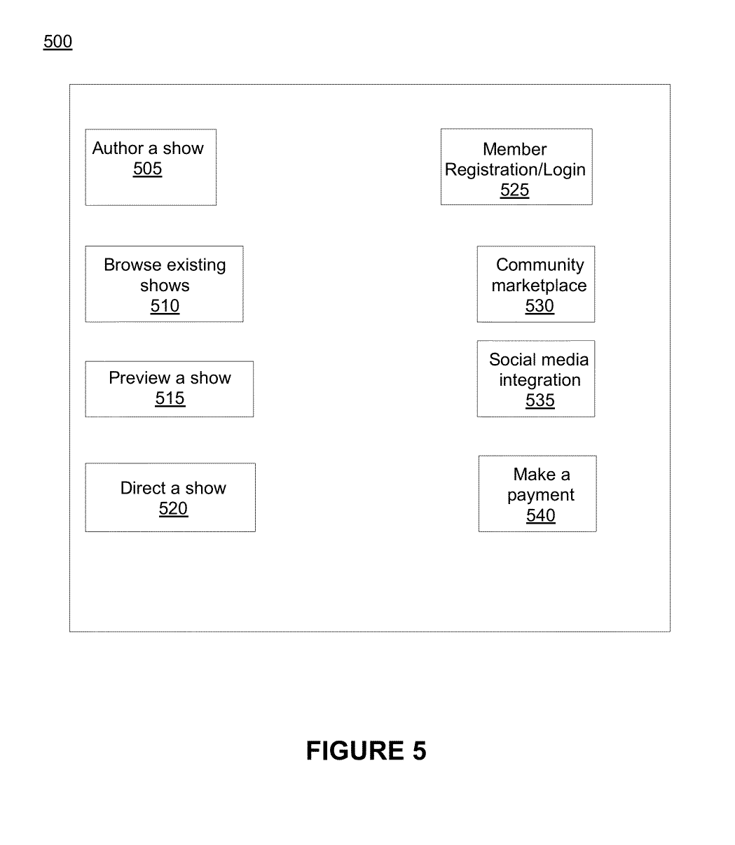

Instructions for operating a single entertainment unit 200 and/or multiple entertainment units 200 to produce a show may be provided for download to an entertainment unit 200 by a server hosting an interface (e.g., graphical user interface (GUI)) on a client/computing device (e.g., laptop computer, tablet computer, or smart phone). One example of such an interface is provided by FIG. 5, which depicts interface 500. Interface 500 includes buttons, or user selectable options, as follows: an author of a show button 505, a browse existing shows button 510, a preview a show button 51.5, a direct a show button 520, a member registration/login button 525, a community marketplace button 530, a social media integration button 535, and a make a payment button 540. In some instances, access to one or more of the buttons 505-540 made be dependent upon a user entering proper member registration and/or login information following, for example, selection of member registration/login button 525.

A person of skill in the art will understand that the buttons of interface 500 may be arranged in any order and may be selected by a user in any order or preference and that the buttons of interface 500 may take any form (e.g., dropdown menus, tabs, etc.). It would also be understood by a person of skill in the art that one or more of the buttons 505-540 provided on interface 500 may also appear on other screens provided by the server and/or client device. Furthermore, it would be understood by a person of skill in the art that selection of one or more buttons 505-540 may cause one or more new interfaces to be displayed on the client device in order to, for example, facilitate the underlying purpose that a button represents.

A user may initiate the authoring and/or modification of show by selecting the author a show button 505. Following selection of the author of a show button 505, a user may be, for example presented with another interface or series of interfaces by which the user may be able to design and/or configure a show to be played by one or more entertainment units 200 by, for example, selecting various lights, sounds, images, animations, and/or sprites to be played by a single entertainment unit 200 or an array of entertainment units 200. The user may also be able to set a schedule, pace, recurrence pattern, or other user-configurable preferences for playing them. In some instances, a user may post an authored show to the server for viewing/purchase by other users.

A user may access pre-designed shows via selection of the browse existing shows button 510. In some instances, the accessed shows may have been authored by the user and/or be in the public domain (i.e. downloadable without payment of a fee). In other instances, the user may be required to pay a fee to access or download these pre-designed shows via selection of, for example, the make a payment button 540. Downloaded and/or created shows may he communicated to one or more entertainment units 200 via wired and/or wireless communication (e.g., BLUETOOTH™, Infrared, NFC, BLUETOOTH™ Low Energy (BLE), etc.) received by a communication port wireless transceiver 120. At times, an entertainment unit 200 or a device controlling the entertainment unit 200 may have access to multiple shows, which may be played by the entertainment unit 200 in succession in a manner similar to a song play list. in some instances, the accessed show may include, for example, a node, show protocol, ATP, time, and/or a log entry showing use or characteristics of a particular show.

When authoring a show it may be designed and previewed using, for example, a show preview canvas. The canvas may be processed with visual effects defined using, for example, the Processing.org domain specific language. Processing.org is a programming language, development environment, and online community. Since 2001, Processing.org has promoted software literacy within the visual arts and visual literacy within technology. Initially created to serve as a software sketchbook and to teach computer programming fundamentals within a visual context, Processing.org has evolved into a development tool for professionals. Today, there are tens of thousands of students, artists, designers, researchers, and hobbyists who, use Processing.org for learning, prototyping, and production. See http://processing.org.

In some embodiments, one or more entertainment units 200 may act to provide a notification to indicate to a user that an event has occurred by, for example, playing a particular color or sound and/or sequence of colors and/or sounds. Exemplary events include social media notifications (e.g., FACEBOOK™ or INSTAGRAM™ posts), a calendar event, receipt of an e or text (SMS) message, or a time of day (for example, changing color every hour or at the top of the hour). Entertainment units 200 may be directly or indirectly coupled to event sources to receive an indication of an event or may receive an indication of an event from a computing device. A user may establish a social media integration for one or more entertainment units 200 via selection of the social media integration button 535. Additionally, or alternatively, a user may also be able to post shows and/or information regarding a show to a social media platform via selection of the social media integration button 535.

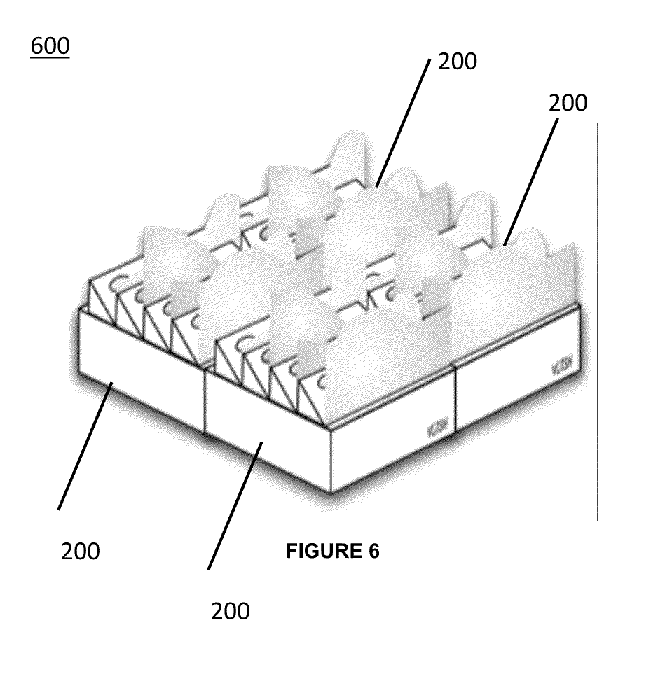

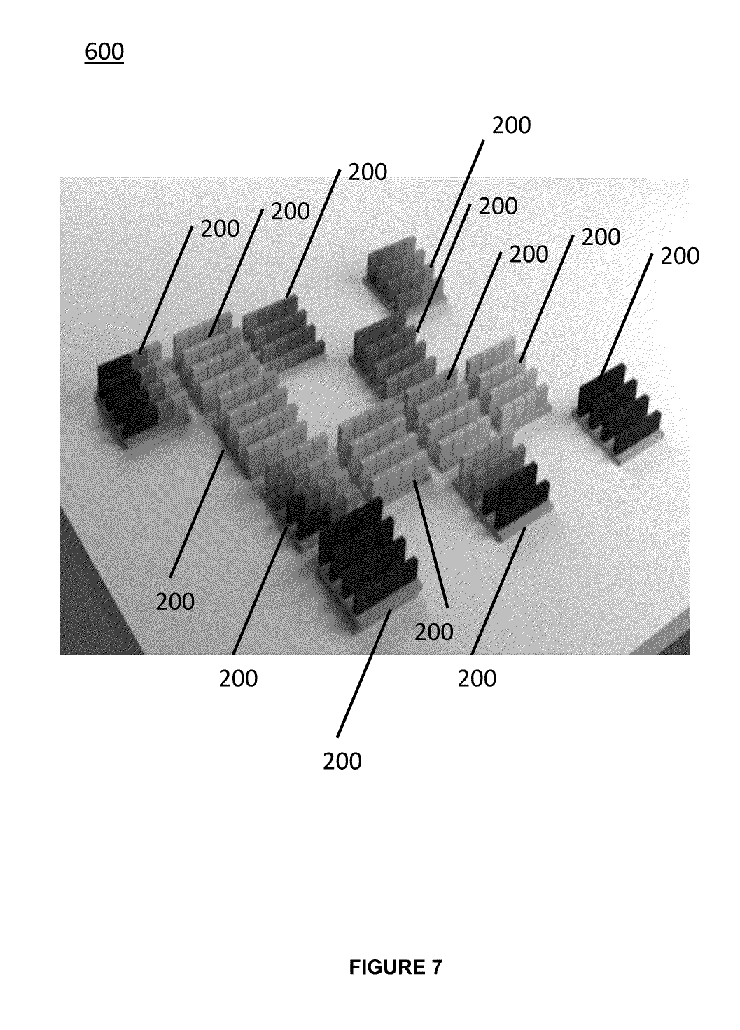

An array of two or more entertainment units 200 may be synchronized with, for example, communication with one another and/or a central controller via, for example, wireless transceiver 120 in order to provide a coordinated light, sound, and/or animated show or display. FIGS. 6 and 7 depict exemplary arrays 600 and 700 of multiple entertainment units 200. FIG. 6 depicts a grid of four entertainment units 200 physically coupled together and FIG. 7 depicts an array of multiple entertainment units 200 dispersed throughout a geographic area, only some of which are physically coupled together. it will be understood by those of skill in the art that the entertainment units 200 need not be coupled together in order to communicate with one another and/or synchronize a show (i.e., provision of sound, light, animation, etc.).

FIG. 8 depicts an exemplary distributed entertainment-operating system 800 for providing an audio-visual display over an array of multiple individual entertainment units 200. In some cases, the distributed entertainment-operating system 800 may be configured to provide schedule-based automated operation of shows. The components of system 800 may be in communication with one another via wired and/or wireless communication links. In some instances the communication links may be made via near field communication (NFC) or other short distance communication protocols (e.g., BLUETOOTH™ or BLUETOOTH™ LTE, and Infrared) using wireless transceiver 120 and/or a wired connection between one or more components of system 800. System 800 may be configured to coordinate a complex series of audio and visual displays over time such that a show is provided by a set of entertainment units 200_{A-N} coordinated to work together.

System 800 may include a plurality of components instantiated as software, hardware, or some combination thereof. For example system 800 may include a show transformation logic engine 801, which may also be referred to as a mid-tier information controller, a server 805, a client device 855, a data store 850, a show controller 840, and a plurality of entertainment units 200_{A-N}. Show transformation logic engine 801 may include an interface 880, a receiving module 820, a transform handler 825, a target application 830, and a sending interface 835.

Show transformation logic engine 801 may be configured to apply transformation logic to source show data received from server 805 to convert the source show data into individual shows for each of a plurality of entertainment units 200_{A-N}. For example, when entertainment unit 200_{A} is configured and/or positioned to be on the left side of an audience or show space then, the transformed show or portion of the show transmitted to entertainment unit 200_{A} may contain only light and sound control data that corresponds to the left side of the overall show environment.

In some instances show data transmitted to individual entertainment units 200 may be adapted to the configuration specifics of one or more individual entertainment units 200. For example, if entertainment unit 200_{A} is configured with a set of 4 diffusion filters 220 in 4 rows then the transformed show runs on the entertainment unit's diffusion filters 220, even if the show is designed for entertainment units 200 with more, or less, than four diffusion filters 220. Conversion of data necessary to accomplish this may be performed by, for example, an entertainment unit 200 _{A-N}, show controller 840, and/or show transformation logic engine 801.

The show transformation logic engine 801 may be configured to receive transport control and media data for an audio-visual show from a source server 805 to a set of entertainment units 200_{A-N} efficiently and with flexibility. The show transformation logic engine 801 may communicate with the source server 805 via interface 880, client device 855, and/or database 850, which may be a wireless transceiver or a hardwired interface (e.g., Ethernet port) to receive audio-visual show data from server 805, client device 855, and/or database 850, and/or transmit information (e.g., specifications for an entertainment unit _{A-N} or array of entertainment units _{A-N}). The audio-visual show data may be in a predetermined format, which may, or may not, be compatible with the components of system 800. For example, a predetermined format may be an OGG or WAV audio format that may be transformed to be compatible with the entertainment unit(s) and or system/environment 800 components.

The interface 810 may transfer the received audio-visual show data to a receiving module 880, which may transfer the received audio-visual data to one or more transformation handlers 825. Transformation handler 825 may be configured to transform the received data into a second predetermined format compatible with a target software application 830, show controller 840, and/or entertainment units 200_{A-N}. The data may then be sent from target application 830 to a sending interface 835 for transmission to show controller 840. The target application 830 may be software installed and/or running within show transformation logic engine 801 and/or an entertainment unit 200_{A-N}. The target application 830 may be configured, when running on an entertainment unit 200_{A-N}, to play a show (e.g., instructs the lighting elements to emit light and the audio processor to play a sound/audio file). In some embodiments, the target application 830 may be configured to provide show transformation logic engine 801 and/or entertainment units 200_{A-N} with video capability as, for example, a video projector application. Show controller 840 may then process the received data (e.g., parse or compartmentalize the data into sets of instructions specific to one or more entertainment units 200_{A-N}) and send the processed data to the relevant entertainment unit(s) 200_{A-N}.

The individual entertainment units 200_{A-N}may include individual lights and/or screens for the display of images or the projection of light and one or more speakers for the projection of sound or music. Entertainment units 200_{A-N} may also be configured to provide various other displays (e.g., fog, mist, scents, etc.). In some embodiments, the entertainment units 200_{A-N} may all be the same, while in other embodiments they may be configured differently. The individual entertainment units 200_{A-N} may be configured to individually provide portions of an audio-visual show in coordination and synchronization with other entertainment units 200_{A-N}.

In some embodiments, the show transformation logic engine 801 is configured to make a wireless network connecting the entertainment units 200_{A-N} to the server 805 more efficient by sending only the show information for each specific entertainment unit 200. The show transformation logic engine 801 may be configured to implement a transformation of show data from the source server 805 so that only the show information/data for each specific entertainment unit 200_{A-N} is transferred to the respective entertainment unit 200_{A-N} and the transformed content uses entertainment unit 200_{A-N} special features.

Embodiments of environment 800 may not require long-term storage or persistence of data within the entertainment units 200_{A-N}, except for the entertainment units 200 ability to store show content for that unit and the server ability to store show content for all entertainment units 200_{A-N}.

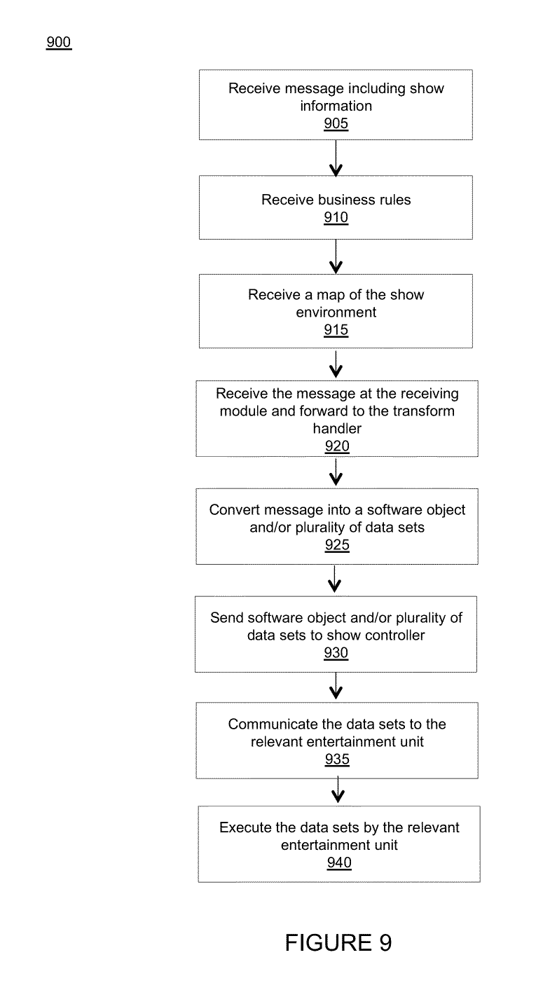

FIG. 9 provides an exemplary process flow 900 for an exemplary operation of show transformation logic engine 801. In general, process 900 shows how the transformation logic engine 801 receives the show data and transforms it for transmission to the individual entertainment units 200_{A-N} based on, for example, the configuration, position, and capabilities of the individual entertainment units.

Process 900 begins with a message containing show control and media data being received by the show transformation logic engine 801 from server 805 via, for example, interface 880 (step 905). One or more business rules may also be received by transformation logic engine 801 from, for example, server 805 and/or show controller 840 (step 910). Business rules may serve to assist transformation logic engine 801 with adapting the received message so that it may be played on one or more entertainment units 200_{A-N}. The received business rules may be communicated to transform handler 825 so that it may process received messages in accordance with process 900 as described below. In one example, a business rule includes specifications for one or more entertainment units 200_{A-N} (e.g., a number of diffusion filters, details regarding a lighting array, power consumption, sound quality, etc.). In another example, a business rule includes instructions for adapting show data and/or the received message to be played on one or more of the entertainment units 200_{A-N}. In this way, business rules may be used to adjust show information so as to be compatible with and/or tailored to a variety of different entertainment units 200_{A-N}.

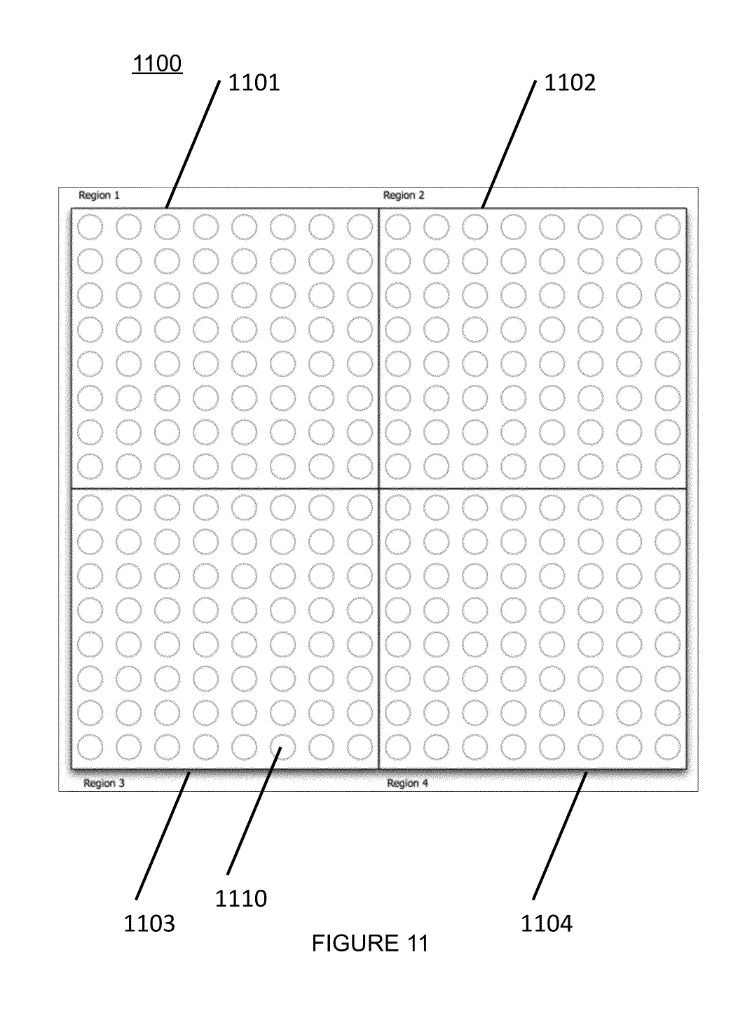

In step 915, a user configurable three-dimensional model of a physical show environment as mapped to individual entertainment units may be received by transformation logic engine 801 from, for example, server 805 and/or show controller 840. Further information regarding mapping entertainment units to a physical show environment is provided below with regard to FIGS. 11-13. Then, the receiving module 820 may receive the message from the interface 880 and forward the received message to transform handler 825 (step 920). Transform handler 825 may then act to convert the message to a software object and/or a plurality of data sets that is communicated to the target application 830 (step 925). In some instances, conversion of the message to a software object may include using the user-configured three-dimensional model of the physical show environment as mapped to individual entertainment units. On some occasions, conversion of the message to a software object may include applying business rules to the message. Additionally, or alternatively, step 925 may include transformation of the message into a plurality of data sets corresponding to regional shows designed to be presented by each individual entertainment unit 200_{A-N}.

The target application 830 may then send the software object and/or plurality of data sets to show controller 840 via sending interface 835 (step 930). Show controller 840 may act to communicate each of the data sets to the relevant individual entertainment unit 200_{A-N} (step 935). In some instances, execution of step 935 may include filtering and/or prioritizing data within the software object according to for example, the configuration, position, and capabilities of the individual entertainment units 200_{A-N}. Exemplary capabilities of individual entertainment units 200_{A-N} include, but are not limited to, the resolution with which visual data may be projected onto or otherwise conveyed by the diffusion filter or series of diffusion filters, a level of sound quality, a level of sound volume, scent producing capability, smoke/fog producing ability, a size of particular entertainment unit 200_{A-N}. Then, at step 940, each of the individual entertainment units 200_{A-N} may execute the respective received data set, wherein execution of the respective data set includes provision of a visual display via one or more of the diffusion filters associated with each respective entertainment unit 200_{A-N}.

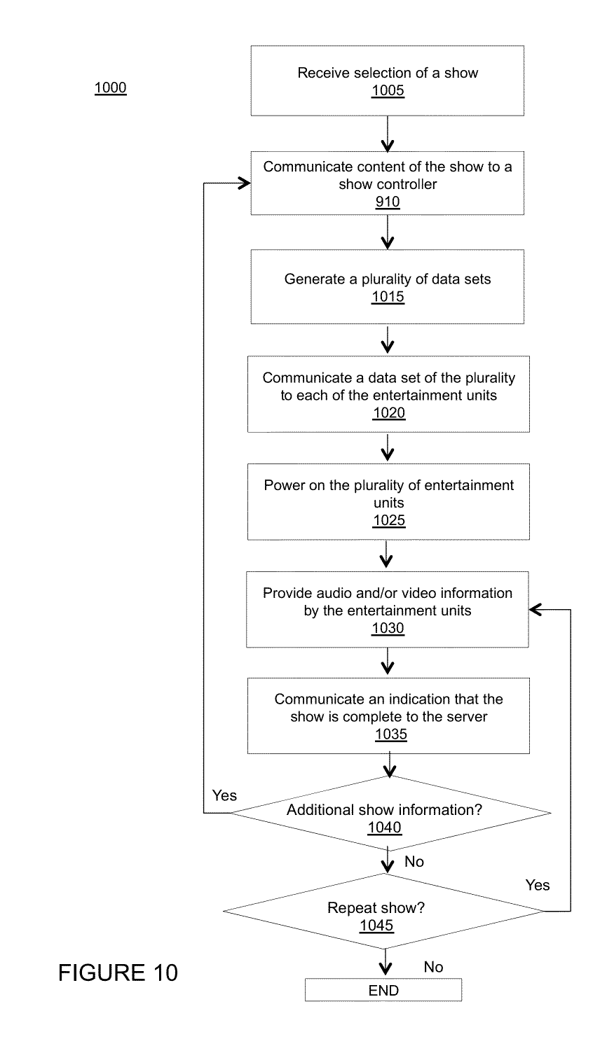

FIG. 10 provides a flowchart depicting an exemplary process 1000 of generating a show for provision by a plurality of entertainment units 200_{A-N}. Initially, a selection of a show to be provided by the plurality of entertainment units 200_{A-N} may be received (step 1005) by, for example, show transformation logic engine 801 from, for example, a user via a client device such as client device 855. On some occasions, step 1005 may also include receiving a start time for the selected show, control running control protocols (e.g., run, pause, and stop), and other data and/or sets of instructions for running a show.

In step 1010, the server may communicate the contents of the selected show, which may include, for example, data regarding sound, light, and/or special effect content, to the show controller 840, which may be configured to transform the show data into data sets playable on individual entertainment units 200_{A-N} using a show protocol, which may be a proprietary communication protocol capable of generating a plurality of data sets including, but not limited to, command and control protocols for the individual entertainment units 200_{A-N} (step 1015). The data sets may be specifically adapted for a particular entertainment unit, based on one or more criteria associated with the entertainment unit 200 (e.g., position, configuration, audio resolution, light resolution, etc.). In step 1020, the data sets may be communicated to the individual entertainment units 200_{A-N}. by, for example, a show controller like show controller 840.

Next, the show controller 840 may start, or power on, the entertainment units 200_{A-N} so that they may be synchronized in their operation and provision of the show (step 1025). Then, the individual entertainment units 200_{A-N} may provide the audio and/or visual display of the selected show according to the command and control protocols designed for, and received by, the individual entertainment units 200_{A-N} for observation by individuals in proximity to the entertainment units 200_{A-N} (step 1030).

Upon completion of the show, the show controller 840 may signal server 805 that the show is complete (i.e., a signal indicating a completed show state) (step 1035). The server may then determine if there is an additional show selected by the user (step 1040) and/or if the user has instructed the show to repeat from the beginning (step 1045). When the user has instructed the show to repeat from the beginning, then steps 1030 and 1035 may repeat themselves, provided that the individual entertainment units 200_{A-N} have enough on-board memory to store the communicated data sets (step 1020). When the individual entertainment units 200_{A-N} do not have enough on-board memory to store the communicated data sets, then steps 1020 and 1025 may also be repeated. If there is an additional show selected by the user, then steps 1005-1035 may be executed with the additional show.

### Sprite Definition and Rendering of Multiple Media Types Across Multiple Distributed and Coordinated Three-Dimensional Show Spaces

An alternate embodiment for defining light and sound animation shows, including sprites, presented on multiple entertainment units 200 is described below. Sprites are shows, or portions thereof, that exist within a large three-dimensional space named “the grid.” A pixel is an abstract measure of space within the grid. Additionally, within the grid are three-dimensional regions and each entertainment unit 200 maps to a unique region. A user may configure or map regions of the grid to entertainment unit(s) 200 using configuration instructions via, for example, a computing or client device like client device 855. Additionally, pixels within each region may map to one or more entertainment unit(s) 200 which may include, for example, including lights, speakers, video projectors, lasers, fire emitters, and smoke emitters.

In some instances, a sprite is a rich media element placed on a grid of pixels that span across one or more regions populated with entertainment units 200. A region is an area that maps to an entertainment unit 200. Sprites may be colored objects (square, circle, line), audio recording, video recording, and/or animated cells. Exemplary sprite types supported by entertainment units 200 or components of environment 800 include, for example:
a) Light—a circular pool of color;
b) Image—a static JPEG or PNG image;
c) Video—an MPEG encoded media file;
d) Type—using standard TrueType fonts. Type sprite types defines the font, size, and color;
e) Shape—triangle, square, circle, line. Shape sprite types also define size and fill pattern;
f) Music—sound and audio files;
g) Sound Effects—sound and audio files;
h) Cell Animation—cell based animation, including image rotation, speed, and repeat values;
i) Shape—an STL-based three-dimensional object definition; and
j) Projection Onto Shape—Image mapped to a shape in three-dimensions.

A cue is an instruction to one or more sprites regarding how to animate, move, and/or create sound within the grid of unit regions. An audio cue may be music or sound effects. A sequence is a grouping of cues and a show may be a grouping of cues and sequences. The relative distance and position of each of the entertainment units 200 within a grid may be used to determine how to provide a sequence of displays within a show and the timing of the sequence and may thereby be used to generate cues.

In the following example, a network of four entertainment units 200 is positioned in a square-shaped grid 1100 as shown in FIG. 11, which includes region 1 1101, region 2 1102, region 3 1103, and region 4 1104. Each of the regions 1-4 1101-1104 has eight rows and eight columns of pixels 1110 (64 in total). An entertainment unit 200 may be placed in any position or orientation within a region. It will be appreciated by those of skill in the art that although the regions depicted in FIGS. 11 are square, regions A-D 1101-1104 may be of any shape or combination of shapes, such as a square, polygon, circle, or irregular shape. Regions allow cues of sprites to move from one region to another smoothly, including audio music and sound effects.

Using the regional map, relationships between two or more entertainment units 200 may be established so as to, for example, provide smooth transitions of the displays provided by the multiple entertainment units 200 within the grid. In some embodiments, the regional map may be used to determine a distance and/or relative position between entertainment units 200 within the grid so that sequences of displays may be coordinated between the entertainment units 200 in a pattern (e.g., from left to right, top to bottom, or randomly). Also, it should be noted that although the regional map of FIG. 11 is two dimensional, a regional map may also be three dimensional with entertainment units 200 placed at varying distances in the X, Y, and Z Cartesian planes.

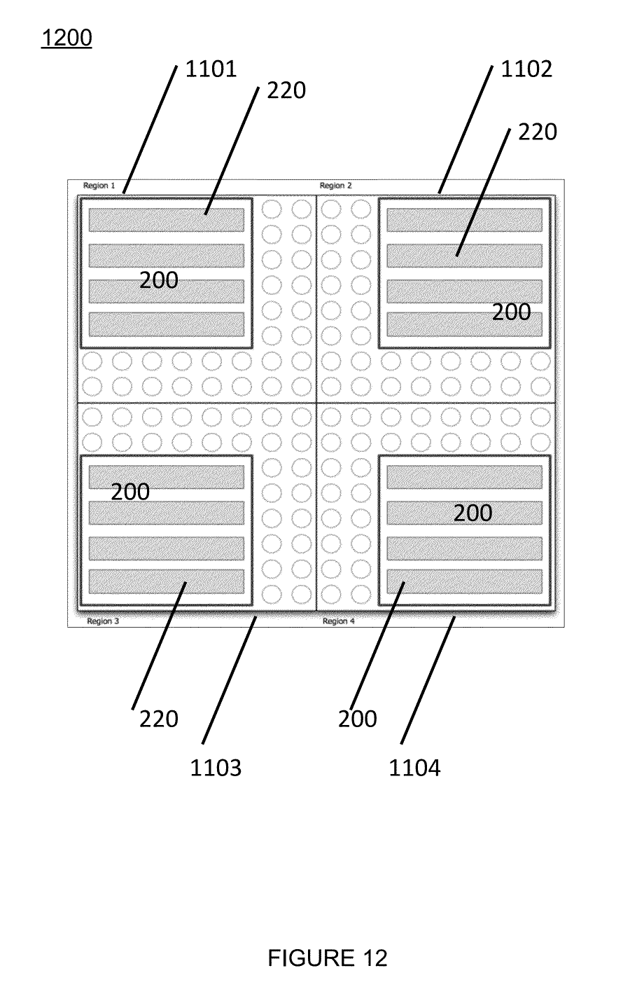

In one embodiment, entertainment units 200 may be positioned within each region of grid 1200 such that the entertainment units 200 are not directly connected or next to one another. Such a configuration may be represented on a regional map as depicted in FIG. 12. In this configuration, the entertainment units 200 are represented with squares including horizontal lines, which represent the diffusion filters 220 of the respective entertainment units 200 and the space between the entertainment units 200 shows unused pixels. The invention maps the relationship to the device to provide smooth unpixelated animation.

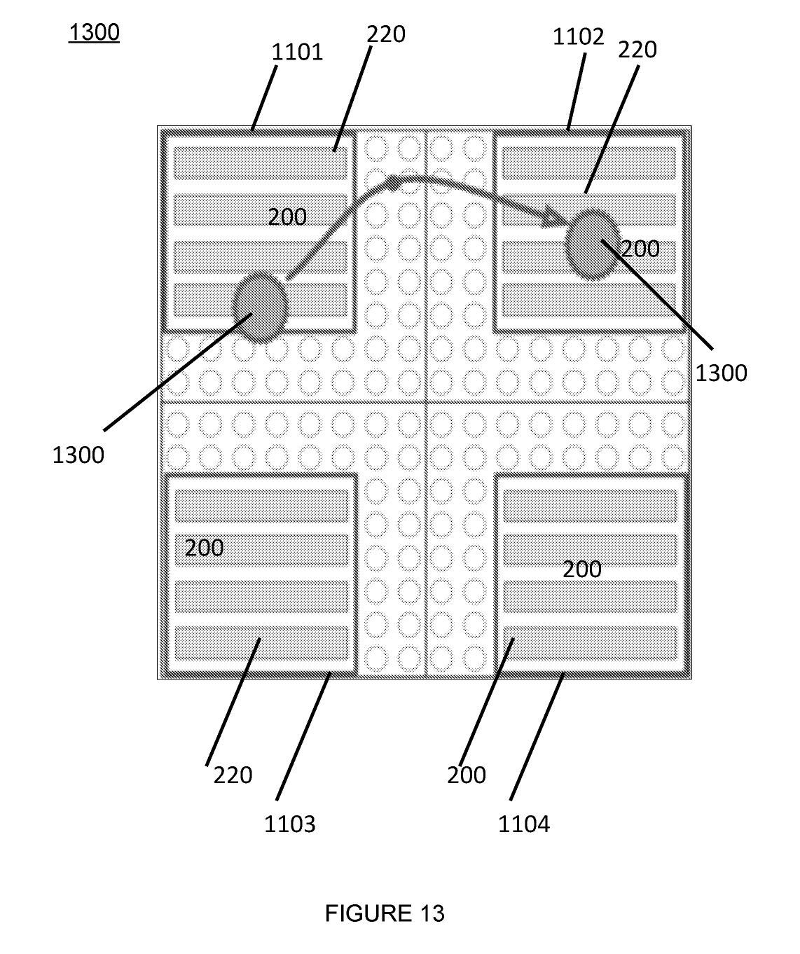

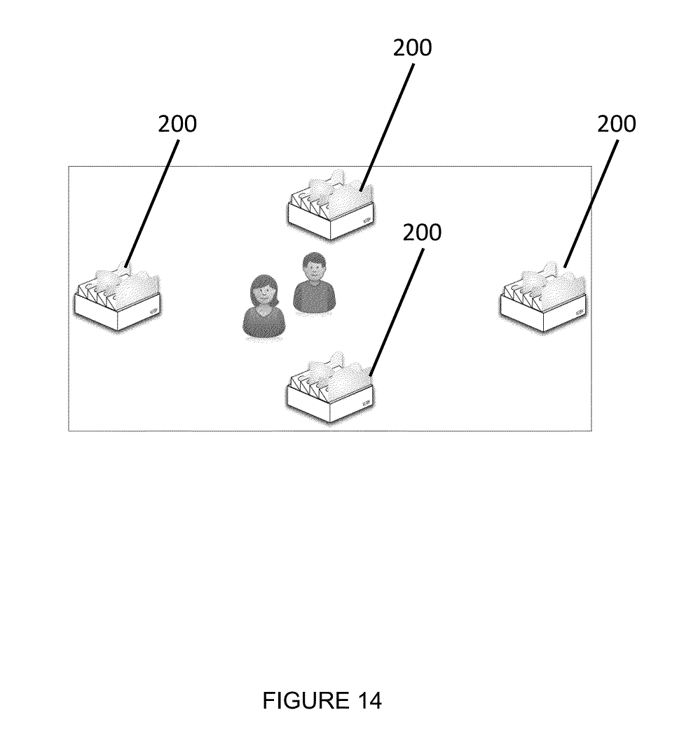

Once the regional map 1200 is set up, cues for sprites 1300 or other audio and/or video data may move from one entertainment unit region to another smoothly, including audio music and sound effects as shown in FIG. 13. This movement may be facilitated by communication between the entertainment units 200 or by a synchronized set of instructions transmitted to each entertainment unit. For example, a show controller 840 or transformation logic engine 801 may send show data to each of the four entertainment units 200 such that each individual entertainment unit 200 displays the sprite in a synchronized fashion because the individual entertainment units 200 are instructed to display the sprite 1300 at different, sequential times such that display of the sprites 1300 moves around the room. FIG. 14 depicts two individuals positioned within an array of entertainment units 200 so as to observe presentation of a show by the plurality of entertainment units 200.

In some embodiments, pre-defined shows may be adapted by one or more components of environment 800 to be played by multiple entertainment units 200 within a geographic area using a regional map. In other embodiments, the regional map may be used to assist with the design or generation of a show to be played by the multiple entertainment units 200. In this way, shows may be configured for specific environmental conditions and may be unique to a particular environment.

### Mesh Network Transfer Protocol for Large Files

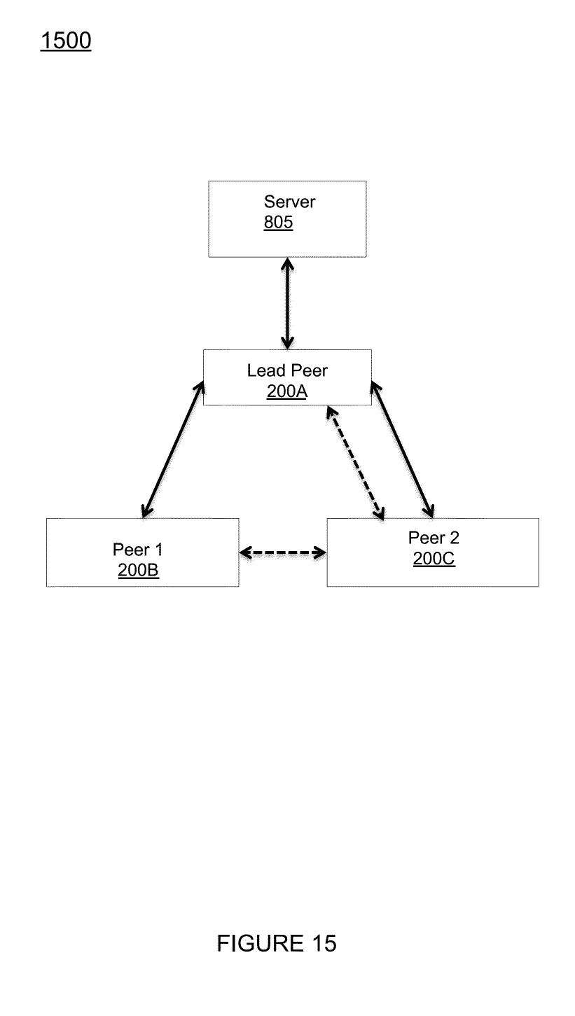

A transfer protocol is herein disclosed to make use of the unique characteristics of a mesh network and stack to transfer information between peer entertainment units 200 and components of environment 800 to provide a show to an observer. A mesh network, as disclosed herein, enables automatic routing and forwarding of data through peers, such as entertainment units 200. An exemplary mesh network 1500 and stack is depicted in FIG. 15, wherein a lead peer 200_{A} is communicatively coupled to a server 805, peer 1 200_{B} and peer 2 200_{C}. Peer 1 200_{B} is also communicatively coupled to peer 200_{C}. While in use, if the lead peer 200_{A} intends to send data to peer 2 200_{C}, it may do so directly or via transmission of data to peer 1 200_{B} for eventual transmission to peer 200_{C}.

The Transfer Protocol (ATP) described herein is a transfer protocol for moving data between peers across mesh networks. The ATP uses a long-polling push pattern to initiate a transfer of data across the mesh network. For example, the lead peer may send a message to peer 1 200_{B} indicating intent to transfer data. The message may include a reference to the data, a size of the data to be transmitted, and a chunk size appropriate to a data and/or network type. The lead peer 200_{A} may then proceed with doing other tasks.

Upon receipt of the message, peer 1 200_{B} may send a series of pull requests to the lead peer 200_{A} requesting, for example, individual chunks of the data to be transmitted referred to in the message sent by the lead peer 200_{A} to peer 1 200_{B}. At times the pull requests may be sent to the lead peer 200_{A} concurrently. Peer 1 200_{B} may then receive one or more of the requested chunks and may proceed to save the chunks to the right place in, for example, a buffer or in a file in a SDRAM card.

Peer 1 200_{B} may keep track of each requested and/or received chunk and may prioritize them in, for example, sequential order. In some cases, peer 1 200_{B} may put a higher priority on the lower chunk numbers. If peer 1 200_{B} receives higher chunk numbers first, it may send a retry request for the lower chunks.

The stack on peer 1 provides an API for applications running on peer 1 200_{B} to use the received chunks and optionally wait for all the chunks to be received. Peer 1 200_{B} may, in some circumstances, use checksum values to certify each chunk was correctly received and stored. In some embodiments, the receiving peer may identify data encoding, compression, and security techniques. A receiving peer may also be configured to dynamically change chunk size, data encoding, compression, and security techniques in response to actual transfer speeds and efficiency.

In some embodiments, the ATP may be a streaming protocol. Applications running on one or more peers in the mesh network may use transferred data while the transfer is in progress. The ATP may be configured to run on top of multiple types of network stack, including, for example, LWM and telehash. In many instances, the ATP may not require the stack to provide reliability, out-of-order transmission, packet, or stream based APIs.

The ATP protocol may operate without a callback mechanism to signal successful transfer of chunks between the lead peer 200_{A} and a receiving peer 1 200_{B} or entertainment unit 2 200_{C} Instead, the receiving peer is responsible for requesting and receiving chunks, including retries. The ATP is compatible with various wireless network protocols including IEEE 802.15.4 mesh network, Wi-Fi, Bluetooth, and Ethernet networks, including TCP and UDP protocols.

The ATP may act to optimize data chunks and communications for a small memory footprint or according to data transmission rates. The ATP may be configured to enable transfer data sets up to, for example, 4 Gigabytes long, in chunks from 1 to 65K bytes long and may provide memory allocation for the transferred data, including expiration.

Some capabilities and advantages to the distributed entertainment-operating environment 800 are as follows:

1) The show transformation logic engine 801 may be configured to produce a multi-dimensional grid that encompasses all the entertainment unit 200 play regions from a single set of show data. The show data does not need to include information regarding how to generate the multidimensional grid or a show for each entertainment unit within the grid. Instead, the show transformation logic engine 801 receives the show data and makes the determinations of what each individual entertainment unit 200 should do and then transmits a data set with instructions targeted for each individual entertainment unit 200 within the multi-dimensional grid. In this way, each entertainment unit 200 does not receive all the data, instead it receives only the data it needs to perform its specific role. Using the transformation engine in this way saves memory and processing power/time at the individual entertainment units 200 and, as such, the individual entertainment units 200 only require enough memory to render the grid local to the individual entertainment unit. The individual entertainment units 200 do not need to process the data or render the entire grid, just the grid local to the individual entertainment unit 200. This increases efficiency and speed of operation for environment 800.

2) The show transformation logic engine 801 may be configured to receive information regarding the capabilities/configuration of the individual entertainment units 200_{A-N} from, for example, the individual entertainment units 200_{A-N}, show controller 840, server 805, and/or an external component (via, for example, interface 880). In some embodiments, show transformation logic engine 801 may be configured to adapt regional show data sent to individual entertainment units 200 based on a level of resolution or fidelity of an associated individual entertainment unit. In this way, individual entertainment units 200 throughout the grid may have different capabilities (e.g., light and/or sound resolution) and these different capabilities will not disrupt presentation of the show.

3) Environment 800 enables the efficient distribution of control data and light and sound media to a distributed environment of entertainment units 200 because, for example, only data targeted to a specific entertainment unit 200 is sent to that entertainment unit. In this way, the individual entertainment units 200 do not receive data they do not need, saving time, processing power, and storage resources.

4) Environment 800 enables a user to define the light and/or sound space within a three-dimensional physical environment populated with individual entertainment units 200 that are remotely located.

5) The show transformation logic engine 801 may be configured to transform control data as well as light and sound media in mid-tier computing environments positioned between a backend server (e.g., server 805) and entertainment units 200_{A-N}.

6) The show transformation logic engine 801 may be enabled to transform data regarding light intensity, sound pitch, tempo, luminosity, color pallet, volume, and quality.

I claim:

1. A method comprising:
receiving, by a transition logic engine, a set of business rules from a server;
receiving, by the transition logic engine, a three-dimensional model of a physical show environment as mapped to a plurality of entertainment units from the server, each of the entertainment units including a plurality of diffusion filters;
receiving, by the transition logic engine, a message containing show control data and media data from the server;
transforming, by the transition logic engine, the message into a plurality of data sets with each data set of a plurality corresponding to a different one of the entertainment units of the plurality of entertainment units using the set of business rules and the three-dimensional model, wherein each data set includes instructions for the display of light on one or more of the plurality of diffusion filters located on each of the individual entertainment units;
communicating, by the transition logic engine, the plurality of data sets to a show controller coupled to each of the plurality of entertainment units;
providing, by the show controller, a data set to each of the plurality of entertainment units; and
executing, by each of the plurality of entertainment units, the received data set.

2. The method of claim 1, wherein the three-dimensional model is generated by the transition logic engine.

3. A method comprising:
receive a selection of a show to be run on a plurality of entertainment unit at a server, the show comprising at least one of audio data, visual data, and animation data, wherein each entertainment unit includes a plurality of diffusion filters which are configured to diffuse light;
communicating, by the server, the selected show to a transformation logic engine, the transformation logic engine including a data store for storing specifications for each of the plurality of entertainment units;
converting, by the transition logic engine, the show into a resolution playable on each of the entertainment unit using the specifications;
communicating by the transition logic engine, the converted show content to a show controller;
using, by the show controller, a show protocol to generate a show data set for each entertainment unit of the plurality of entertainment units, the show data sets being tailored to the specifications of each entertainment unit so as to be played on the diffusion filters of each respective entertainment unit;
communicating the generated show data set to each respective entertainment unit; and
providing, by each of the plurality of entertainment units, a visual display of the selected show via the diffusion filters of each respective entertainment unit of the plurality of entertainment units.

4. The method of claim 1, wherein the command and control protocols for each entertainment unit of the plurality of entertainment units are generated according to a physical location of each respective entertainment unit within a show space.
